(19) United States
(12) Patent Application Publication
(10) Pub. No.: US 2006/0098444 A1
(43) Pub. Date: May 11, 2006

(54) Lighting system

(76) Inventor: Anthony Petruzzi, Westhampton, NJ (US)

Correspondence Address: Joseph R. DelMaster, Jr., Esquire;Drinker Biddle & Reath LLP, Suite 1100, 1500 K Street N.W., Washington, DC, 20005, US

(21) Appl. No.: 11/204,720

(22) Filed: Aug. 16, 2005

Related U.S. Application Data
(60) Provisional application No. 60/602,038, filed on Aug. 17, 2004.

(51) Int. Cl. F21S 8/06

(52) U.S. Cl. 362/404; 362/224

(57) ABSTRACT

A fluorescent lighting system is provided that comprises a base portion, a housing portion suspended from the base portion, a fluorescent lamp mounted in the housing portion, and a plurality of shade elements. One of the plurality of shade elements is coupled to the housing portion to enclose the fluorescent lamp. The shade elements are interchangeable. In an exemplary embodiment, the shade elements are coupled to the housing portion using a series of interlocking snap elements formed in the shade element and the housing portion.

### CROSS-REFERENCE TO RELATED APPLICATIONS

This application claims priority from U.S. provisional patent application No. 60/602,038 filed Aug. 17, 2004, which is incorporated herein by reference in its entirety.

### FIELD OF THE INVENTION

The invention relates to the field of lighting systems, and more specifically, to a modular fluorescent lighting system with interchangeable shade kits.

### BACKGROUND OF THE INVENTION

Fluorescent lighting systems are commonly used in various applications. Fluorescent lighting systems are energy efficient and provide significant amounts of light while at the same time fluorescent lights do not generate a high volume of heat often associated with incandescent lighting.

Until recently, fluorescent lighting fixtures have been used primarily in office and commercial environments. The efficient high output lighting provided by fluorescent lights make them a preferred choice for such environments, but because of the size and structure of most fluorescent fixtures, they have not provided the aesthetics normally desired in most residential applications. Additionally, previous attempts at aesthetically pleasing fluorescent lamps have provided lamps that could be used in a single configuration. Often, it is desired to vary the look of a lamp shade, as well as the light diffusion level, in a fluorescent lamp to adjust to a particular desired lighting condition. This generally requires replacement of the entire lamp fixture.

What is desired is a fluorescent lighting system that overcomes the above described shortcomings. This invention fulfils this need, among others.

### SUMMARY OF THE INVENTION

A fluorescent lighting system is provided that comprises a base portion, a housing portion suspended from the base portion, a fluorescent lamp mounted in the housing portion, and a plurality of shade elements. One of the plurality of shade elements is coupled to the housing portion to enclose the fluorescent lamp. The shade elements are interchangeable. In an exemplary embodiment, the shade elements are coupled to the housing portion using a series of interlocking snap elements formed in the shade element and the housing portion, although various mounting techniques (e.g., clips, screws, etc.) could also be employed.

Additionally, the distance at which the housing portion is suspended from the base portion is adjustable, allowing the housing portion and shade element to be set to hang various distances from the base portion. This allows for a variety of lamp configurations.

In an exemplary embodiment, the lighting system comprises a base portion, a housing portion suspended from the base portion, a fluorescent lamp mounted in the housing portion, a plurality of shade elements, with at least one shade element is coupled to the housing portion enclosing the lamp, wherein the shade elements are interchangeable.

### BRIEF DESCRIPTION OF THE DRAWINGS

For the purpose of illustrating the invention, there is shown in the drawings a form which is presently preferred; it being understood, that this invention is not limited to the precise arrangements and instrumentalities shown.

FIG. 1 is a perspective view of the lighting system without a shade element

FIG. 2 is a perspective view of the lighting system of FIG. 1 with a first example of a shade element.

FIG. 3 is a perspective view of the lighting system of FIG. 1 with a second of a shade element.

FIG. 4 is a perspective view of the lighting system of FIG. 1 with a third example of a shade element.

FIG. 5 is a perspective view of the lighting system of FIG. 1 with a fourth of a shade element.

### DETAILED DESCRIPTION OF THE DRAWINGS

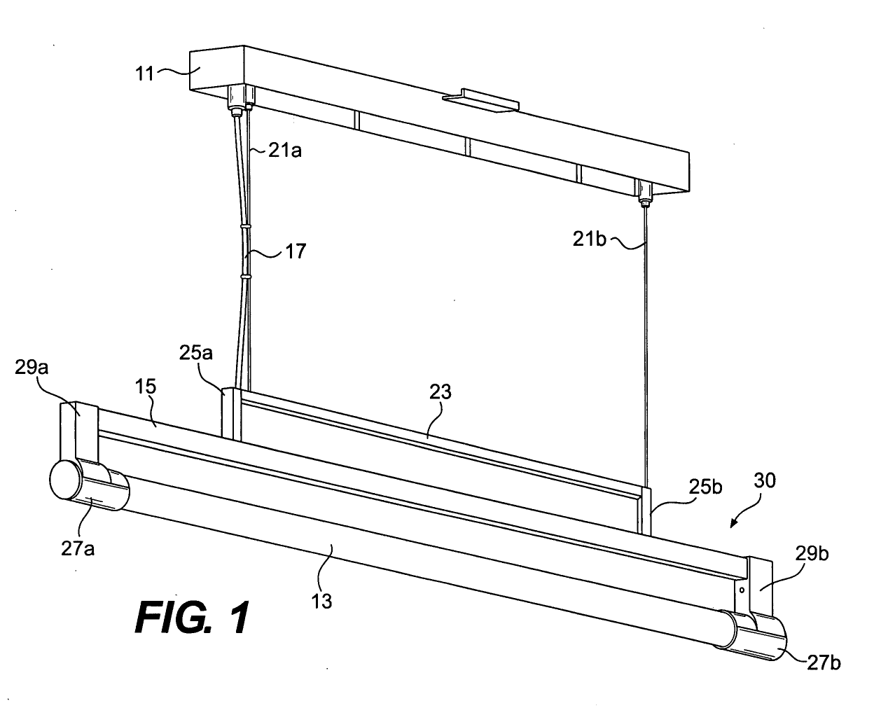

Referring to the drawings, wherein like reference numerals identify like elements, components, subassemblies, etc., FIGS. 1-5 illustrate a lighting system in accordance with an exemplary embodiment of the present invention.

FIG. 1 illustrates a lighting system in accordance with an exemplary embodiment of the present invention that does not have any shade element attached. The system 10 comprises a base portion 11. The base portion 11 is mounted in a fixed position, for example, to the ceiling of a room. In an exemplary embodiment, the control elements (e.g., ballast, dimming electronics, etc.) may be located with the base portion 11. Alternatively, such elements could be located above the ceiling to which the unit is mounted. In an exemplary embodiment, the base portion 11 comprises a lightweight metal material, although other materials could also be used.

A plurality of cables 21a, 21b extend from the base portion to a suspended portion 30. In the exemplary embodiment illustrated in FIGS. 1-5, two cables are used. It is, however, understood that various numbers of cables could be employed to couple the suspended portion 30 to the base portion 11. The cables are coupled to a retractable element (not shown in the figures) inside the base unit. Such elements are well known to those of skill in the art.

In an exemplary embodiment, the suspended portion 30 comprises a pair of end portions 29, each having a lamp mounting portion 27. The suspended portion 30 further comprises a lengthwise member 15. The end portions 29 are coupled to the lengthwise member 15. A lamp 13 is mounted in the lamp mounting portions 27 of the end portions 29. The system 10 can be formed in various sizes to accommodate a lamp 13 of various lengths.

In an exemplary embodiment, the lengthwise member 15 is coupled to a strength member 23 via mounting members 25a, 25b. The strength member 23 provides additional rigidity to the overall lighting system, while at the same time adds an aesthetic quality. It is understood that alternative embodiments may not include the strength member 23. The mounting members 25a, 25b couple the suspended portion to the cables 21a, 21b and to the strength member 23.

A flexible cord 17 extends from the base portion 11 to one of the mounting members 25a. The flexible cord 17 provides a conduit for the necessary wires required to power the lamp 13. The wires extend from the base portion 11 to one of the mounted portions 25a via the cord 17, and further extend through the interior of the lengthwise member 15 to the lamp mounting portions 27a, 27b. This allows for the necessary electrical connection required in order to power the lamp 13.

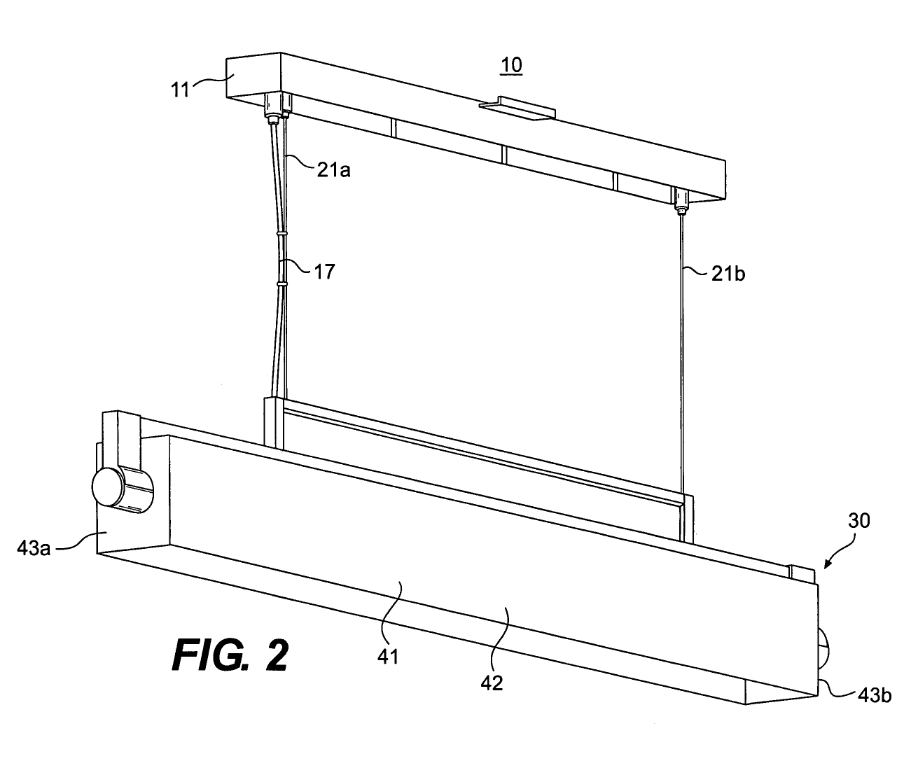

Referring to FIGS. 2-5, the lighting system as shown in FIG. 1 is illustrated with various light shades coupled to the suspended portion 30. The light shades described herein and shown in FIGS. 2-5 can comprise various materials including, but not limited to, plastics (e.g., acrylic, polycarbonate) and/or fabrics (e.g., cloth material). Referring to FIG. 2, a first light shade 41 is coupled to the suspended portion 30 of the lighting system 10. In the embodiment illustrated in FIG. 2, the light shade comprises a rectangular translucent portion 42 and a first pair of mounting portions 43a, 43b. The first light shade 41 is coupled to the suspended portion 30 via the first pair of mounting portions 43a, 43b. In an exemplary embodiment, connection is made between the first shade 41 and the mounting portions 43a, 43b using a pressure fit (e.g., the shade 41 snaps over the lamp mounting portions 27a, 27b of the end portions 29a, 29b). Alternatively, the shade can be coupled using other known techniques such as screws. The rectangular translucent portion 42 forms a shade around the lamp.

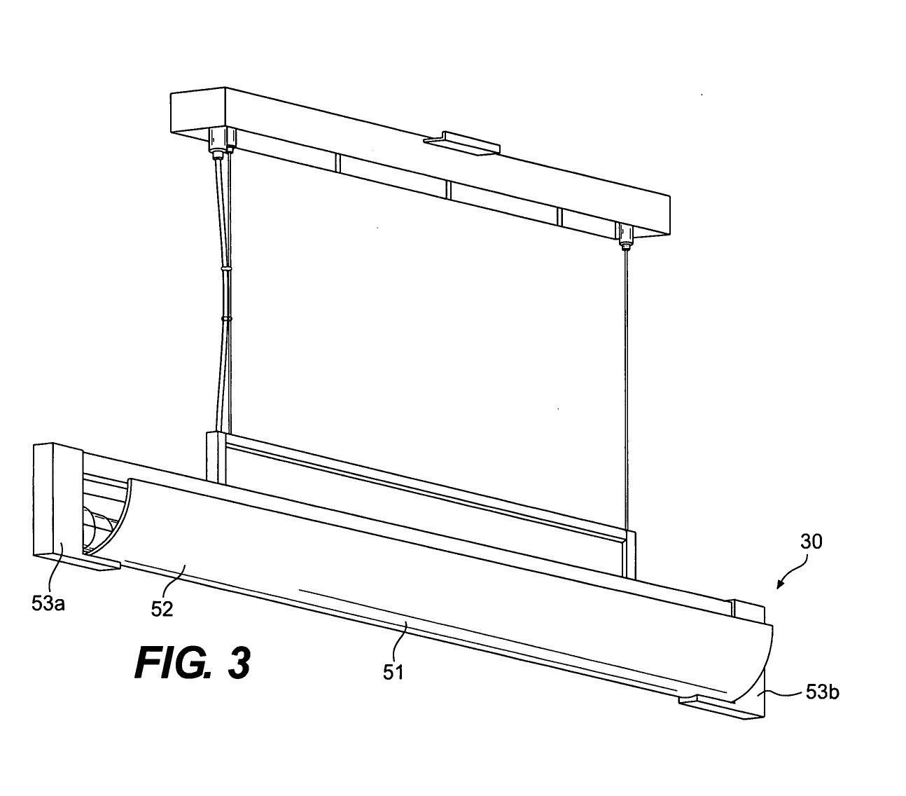

Referring to FIG. 3, a second light shade 51 is illustrated coupled to the suspended portion 30. The second configuration 51 comprises a first semicircular translucent portion 52 and a second pair of mounting portions 53a, 53b. The first semicircular translucent portion 52 forms a shade around the lower side of the lamp, while the top side of the lamp is un-shaded. The second pair of mounting portions 53a, 53b are coupled to the translucent portion 52 and fit over the end portions 29a, 29b (not seen in FIG. 3). The coupling can be achieved via pressure fitting, screws, or any other well know attachment methods. The first semicircular translucent portion 52 provides a different aesthetic look as well as a different level of light diffusion and a different level of light transmission (i.e., shading to the light fixture shown in FIG. 1) than is provided by the shade shown in FIG. 2.

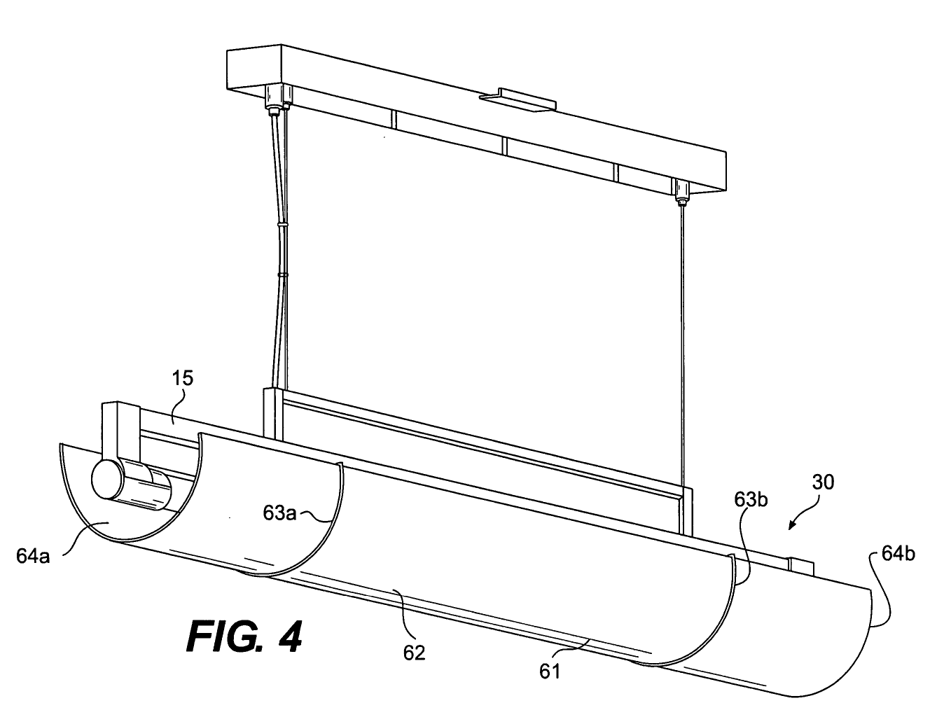

FIG. 4 shows a third light shade 61 coupled to the suspended portion 30. The third configuration 61 comprises a second semicircular translucent portion 62 and a third pair of mounting portions 63a, 63b. The second semicircular translucent portion 62 forms a shade around the lower side of the lamp, while the top side of the lamp is un-shaded. The third pair of mounting portions 63a, 63b are coupled to the second translucent portion 62 and fixed to the lengthwise member 15. In this configuration, the ends of the shade 64a, 64b are open. As with the configuration shown in FIG. 3, the second semicircular translucent portion 62 provides a different aesthetic look as well as a different level of light diffusion and a different level of light transmission (i.e., shading to the light fixture shown in FIG. 1) than is provided by the shade shown in FIG. 2 or the shade shown in FIG. 3.

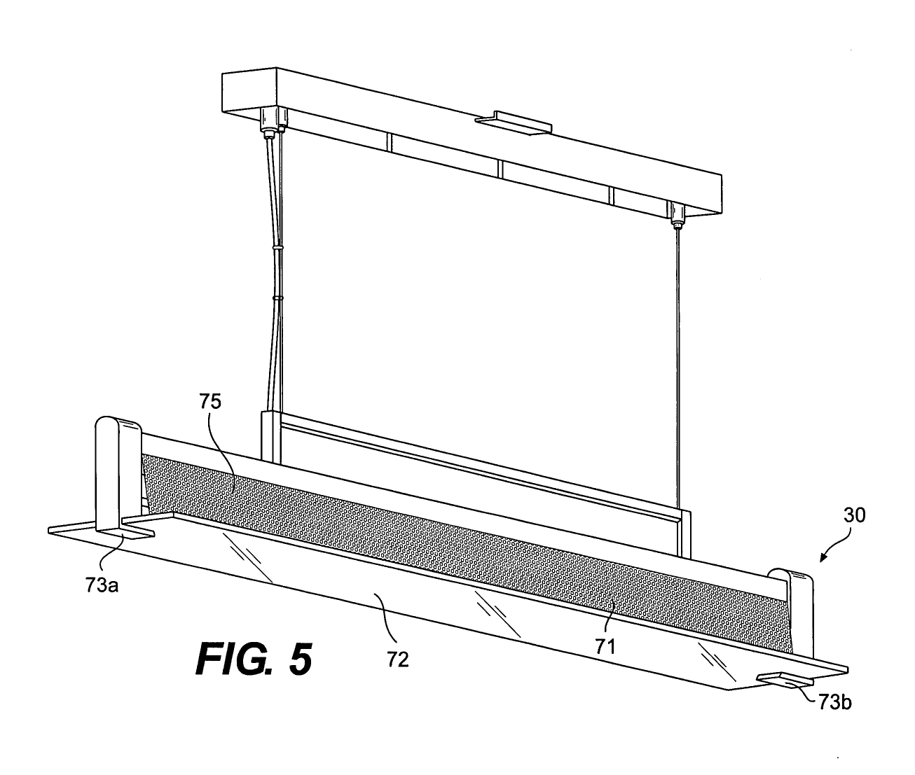

FIG. 5 shows a third light shade 71 coupled to the suspended portion 30. The third configuration 71 comprises a flat portion 72. The flat portion can be transparent or translucent. The flat portion 72 is coupled to a fourth pair of mounting portions 73a, 73b. The fourth pair of mounting portions 73a, 73b are coupled to the end portions (29a, 29b of FIG. 1, not shown in FIG. 5) via known mounting techniques such as screws or a pressure fitting. Additionally, a pair of diffuse portions 75 are coupled to the fourth pair of mounting portions 73a, 73b. The diffuse portions 75 shade the lamp (13 of FIG. 1) and provided a softer lighting environment, a different aesthetic look, and a different level of light diffusion and a different level of light transmission (i.e., shading to the light fixture shown in FIG. 1) than results from the shades shown in the previous figures.

It is understood that while four light shades have been described, many other configurations could be also be used. The lighting system is designed to allow a single light fixture (10 in FIG. 1) to be capable of having a plurality of interchangeable shades. This allows for various lighting conditions as well as various aesthetic configuration. The lamp system in accordance with the present invention creates a fluorescent lamp that is suitable for residential use, while still maintaining the desired efficiency levels associated with prior art industrial fluorescent light fixtures.

A variety of modifications to the embodiments described will be apparent to those skilled in the art from the disclosure provided herein. Thus, the present invention may be embodied in other specific forms without departing from the spirit or essential attributes thereof and, accordingly, reference should be made to the appended claims, rather than to the foregoing specification, as indicating the scope of the invention.

What is claimed is:

1. A lighting system comprising:
a base portion;
a housing portion suspended from said base portion;
a lamp mounted in said housing portion;
a plurality of shade elements capable of being individually coupled to said housing portion, wherein said shade elements are interchangeable.

2. The system as set forth in claim 1, wherein said lamp is a T5 fluorescent lamp.

3. The system as set forth in claim 1, wherein at least one of said shade elements is semi-circular.

4. The system as set forth in claim 1, wherein at least one of said shade elements is substantially rectangular.

5. The system as set forth in claim 1, wherein at least one of said shade elements comprises a clear portion.

6. The system as set forth in claim 1, wherein at least one of said shade elements comprises a diffuse portion.

7. The system as set forth in claim 1, wherein distance between said base portion and said housing portion is adjustable.

8. The system as set forth in claim 1, wherein one of said shade elements is coupled to said housing portion using a pressure fit.

9. The system as set forth in claim 1, wherein a plurality of levels of light diffusion can be achieved by interchanging said shade elements.

10. The system as set forth in claim 1, wherein a plurality of levels of light transmission can be achieved by interchanging said shade elements.

11. A lighting fixture comprising:
a base portion;
a housing portion suspended from said base portion;
a lamp mounted in said housing portion;
a first shade element, wherein said first shade element is interchangeable with a plurality of second shade elements.

12. The light fixture as set forth in claim 11, wherein said first shade element and each of said second shade elements have one of either a unique shape, a unique light diffusion pattern, or a unique light transmission level.

13. The system as set forth in claim 11, wherein said lamp is a T5 fluorescent lamp.

14. The system as set forth in claim 11, wherein said first shade element is semi-circular.

15. The system as set forth in claim 11, wherein said first shade element is substantially rectangular.

16. The system as set forth in claim 11, wherein said first shade element comprises a clear portion.

17. The system as set forth in claim 11, wherein said first shade element comprises a diffuse portion.

18. The system as set forth in claim 11, wherein distance between said base portion and said housing portion is adjustable.

19. The system as set forth in claim 11, wherein said first shade element is coupled to said housing portion using a pressure fit.
